(19) United States
(12) Patent Application Publication
(10) Pub. No.: US 2003/0140902 A1
(43) Pub. Date: Jul. 31, 2003

(54) CNG direct-injection into IC engine

(76) Inventors: Klaus Seifert, Frechen (DE); Thomas Schick, Koeln (DE)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 10/352,345

(22) Filed: Jan. 29, 2003

(30) Foreign Application Priority Data
Jan. 30, 2002 (EP) 02100084.9

(51) Int. Cl. F02B 43/00

(52) U.S. Cl. 123/527

(57) ABSTRACT

The invention relates to a method for operating a four-stroke internal combustion engine with natural gas. In this method, at high to full torque operating conditions, the natural gas is injected directly into the cylinder of the engine toward the end of the induction stroke or at the start of the compression stroke. This may take place in particular in a crank angle range between 210° and 90° before top dead center. The efficiency of the engine is thus improved without generating a gas pressure higher than the storage pressure. It is preferable for the engine to be operated with a stoichiometric air/fuel ratio.

### FIELD OF THE INVENTION

The invention relates to a method for operating an internal combustion engine with natural gas, the natural gas being blown into the combustion chamber at elevated pressure after the induction stroke. The invention also relates to an internal combustion engine, including at least one combustion chamber with an air intake, an intake valve, an air exhaust, an exhaust valve and a controllable device for injecting compressed natural gas, and an electronic control unit, which is connected to the intake valve, the exhaust valve and the injection device.

### BACKGROUND OF THE INVENTION

U.S. Pat. No. 5,329,908 has described an internal combustion engine which is operated with compressed natural gas (CNG). Natural gas predominantly comprises methane (CH₄), and its chemical properties differ significantly from gasoline, which is used as fuel in the great majority of internal combustion engines. When four-stroke, spark-ignition engines are operated on compressed natural gas, in particular its high octane number (ON 120-125) and the fact that the gaseous state is maintained up to a pressure of 300 bar are of particular interest. However, a drawback of using natural gas is the lower volumetric efficiency that results when the gas is inducted into the engine with the air. This is because less air is inducted into the cylinder due to the volume occupied the natural gas. The result is that the amount of air inducted into the cylinder is reduced by approximately 12%.

In this respect, it is proposed, in U.S. Pat. No. 5,329,908, for the natural gas to be blown into the cylinder not during the induction stroke of the engine, but rather at the end of the compression stroke, in the manner of a diesel engine. This requires the pressure of the natural gas in the storage tank to be above 138 bar (2000 psi), so that the natural gas can overcome the pressure prevailing in the cylinder. The natural gas is injected in such a manner that some of it is directed toward the spark plug for immediate ignition. This high pressure exists in the fuel tank when the tank is at least 75% full. Below this level, the pressure is too low for injection into the cylinder near the end of the compression stroke. Consequently, the engine switches to injecting the fuel during the induction stroke. Furthermore, it is proposed in U.S. Pat. No. 5,329,908 to use a pump to actively and continuously maintain the pressure of the natural gas at a sufficiently high level to allow it to be injection toward the end of the compression stroke. However, this entails considerable outlay and additional energy consumption.

### SUMMARY OF THE INVENTION

The method according to the invention is used to operate a four-stroke internal combustion engine with natural gas, the natural gas being injected into the at least one combustion chamber of the internal combustion engine at elevated pressure toward the end of the induction stroke or during the start of the compression stroke. In particular, the natural gas may be injected between 210° and 90° crank angle before top dead center of the piston.

Firstly, injecting natural gas directly near the end of the induction stroke has the advantage that the full quantity of air is inducted, as the air quantity is not affected by the volumetric proportion of natural gas. Consequently, the charge in the cylinder, i.e. the total quantity of the fuel/air mix, increases (slight pressure charging), which in turn leads to the internal combustion engine generating a higher torque and more power. The higher compression pressure which results from the larger total quantity of air/fuel mix has an advantageous effect in this context, since the higher octane number of natural gas compared to gasoline prevents knocking combustion. The efficiency of the engine is therefore improved. The formation of the mixture is improved compared to the direct injection of liquid fuels, since there is no need for evaporation from the liquid to the gaseous. Compared to the prior art, which is known from U.S. Pat. No. 5,329,908 where injection occurs near the end of the compression stroke, the natural gas is injected at an earlier time according to the present invention, i.e. near the end of the induction stroke or during the start of the compression stroke. This has the advantage that a lower natural gas pressure is required for it to be injected. Consequently, the pressure present in the fuel storage tank is generally sufficient. An advantage of the present invention is that high pressure pumps are not needed. A further advantage is that switching to induction of fuel with the air is also avoided.

According to the present invention, fuel injection pressure is less than 25 bar, preferably less than 20 bar. This pressure is sufficient to overcome the compression pressure prevailing in the combustion chamber and corresponds to a typical pressure of the natural gas in the storage system, irrespective of the tank filling level.

Natural gas is preferably stored in a fuel tank at a pressure of more than 15 bar, preferably more than 20 bar. Pressures of this level ensure that a sufficiently high pressure prevails in the storage system itself for natural gas to be injected against the pressure which prevails in a combustion chamber during the compression stroke.

According to a refinement of the method, the internal combustion engine is operated with a stoichiometric air/fuel ratio. Stoichiometric operation has the advantage that an exhaust-gas treatment device, such as for example a three-way catalytic converter, arranged in the exhaust system of the internal combustion engine can remove exhaust emissions with a particularly high level of efficiency.

Furthermore, the proposal that natural gas be injected near the end of the induction stroke or during the start of the compression stroke is preferably only implemented in high and full torque operating conditions of the engine, while otherwise (at low to medium torque conditions) the natural gas is supplied during the induction stroke. This has the advantage that, in the low to medium torque operating range, the natural gas occupies volume induction thereby lessening the amount of throttling and therefore reduces the throttling losses.

Natural gas used in the proposed method comprises substantially methane (CH₄), i.e., 90-100%.

The invention also relates to an internal combustion engine which includes the following components at least one combustion chamber with an air intake, an intake valve, an air exhaust, an exhaust valve and a controllable device for injecting compressed natural gas. The combustion chamber may include a plurality of valves and injection devices. The valves and the injectors can be opened and closed to control the entry of air, the discharge of exhaust gases, and the injection of natural gas, as desired. The engine further includes an electronic control unit which is implemented, according to one embodiment, in microprocessor-based form and which is connected to the intake valve, the exhaust valve, and the injectors.

The electronic control unit is designed to carry out a method of the type explained above. Accordingly, the electronic control unit can control the opening and closing of the intake valve and of the exhaust valve and of the injectors such that the compressed natural gas is injected near the end of the induction stroke or during the start of the compression stroke. This applies at least when the engine is above a medium torque operating condition. With an internal combustion engine of this type, it is possible to achieve the advantages which have been described above, i.e., a higher engine efficiency on account of the “standard” volumetric efficiency and the slight pressure charging additional pumps and substantially independently of the filling level of the natural gas store. Furthermore, the internal combustion engine preferably has at least one storage tank in which the natural gas for consumption can be stored. Furthermore, it is advantageous for an exhaust-gas aftertreatment device, such as for example a three-way catalytic converter, to be arranged in the exhaust path of the internal combustion engine to remove harmful emissions from the exhaust gases.

### BRIEF DESCRIPTION OF THE FIGURES

The invention is explained in more detail below, by way of example, with reference to the figures, in which

FIG. 1 diagrammatically depicts an internal combustion engine according to the invention in the induction stroke,

FIG. 2 diagrammatically depicts the internal combustion engine in the compression stroke,

FIG. 3 diagrammatically depicts the internal combustion engine in the expansion cycle, and

FIG. 4 diagrammatically depicts the internal combustion engine in the exhaust cycle.

### DETAILED DESCRIPTION

The four figures illustrate the successive cycles in an internal combustion engine operated on natural gas according to the invention. A piston 1 moves in a reciprocating manner in a cylinder 2 of the internal combustion engine in a known way, driving a crankshaft 13 via a connecting rod 14. The cylinder 2 has an air intake 3 with a throttle valve 4 inside. At the inlet of the cylinder 2, there is an intake valve 5. Cylinder 2 has an exhaust duct 10 in which there is an exhaust valve 11 in between cylinder 2 and exhaust duct 10. The piston 1 and the cylinder 2 and a cylinder head together delimit the combustion chamber 12.

A spark plug 7 for igniting the air/fuel mixture and a injector 8 for injecting compressed natural gas, which is stored in a gas tank 6, are provided in the cylinder head. Valves 5 and 11, injector 8, and spark plug 7 are connected to an electronic control unit 9, which is typically implemented by means of a microprocessor and controls the engine in the manner described below when it is above a medium torque operating range.

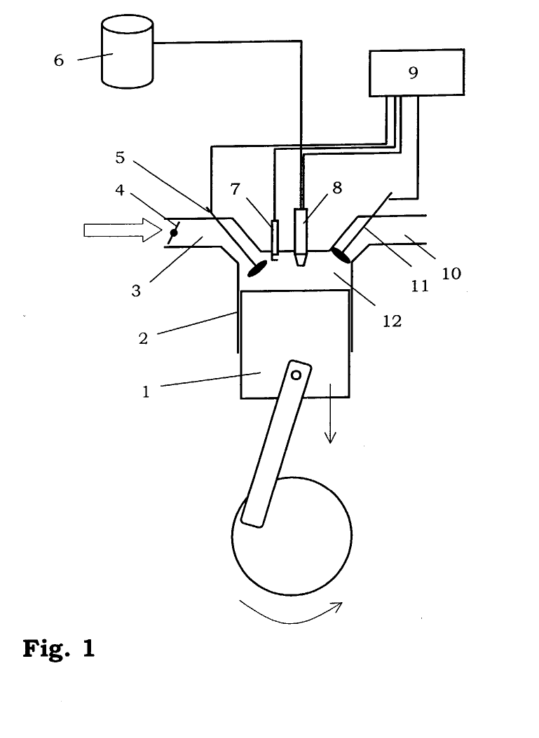

In the induction stroke illustrated in FIG. 1, piston 1 moves downward and inducts fresh air via air intake 3 when intake valve 5 is open.

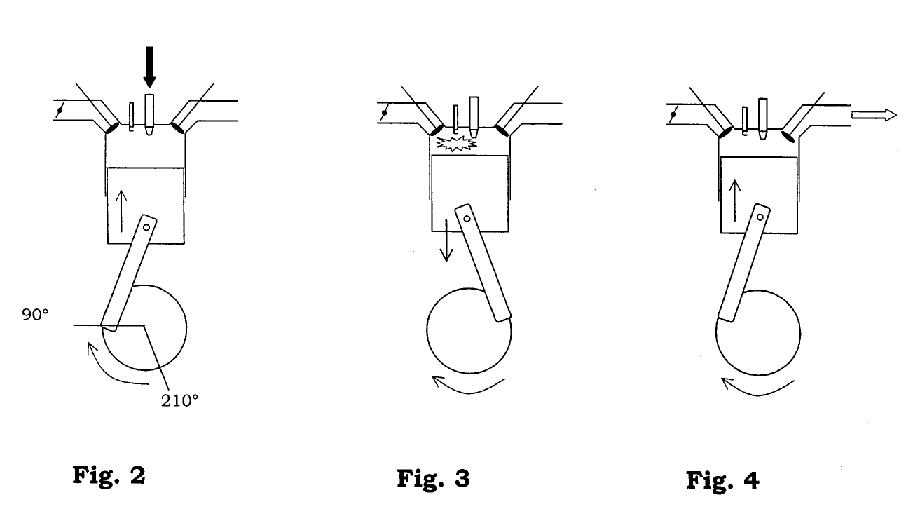

In the compression stroke illustrated in FIG. 2, the intake valve is closed and the piston 1 moves upward. In the process, it compresses the enclosed air, since the exhaust valve is also closed. According to the invention, in this compression stroke natural gas is injected by injector 8 at a pressure of typically 20 bar. Fuel is injected between 210° and 90° before top dead center of the piston, as illustrated.

FIG. 3 illustrates the expansion or combustion stroke, in which the ignited air/fuel mix expands and drives the piston 1 downward. Both valves are closed.

FIG. 4 shows the exhaust stroke, in which the exhaust valve 11 is open, so that the piston can expel the combustion gases from the combustion chamber as it moves upward.

We claim:

1. A method for operating an internal combustion engine with natural gas, comprising: injecting natural gas into the combustion chamber (12) under pressure, said injection occurring near the end of the induction stroke or near the start of the compression stroke.

2. The method of claim 1 wherein said natural gas is injected at a crank angle between 210° and 90° before top dead center of a piston (1), the engine having at least one cylinder with said piston reciprocating within said cylinder.

3. The method of claim 1, wherein said natural gas is injected at a pressure of less than 25 bar.

4. The method of claim 1, wherein said natural gas is injected at a pressure of less than 20 bar.

5. The method of claim 1, wherein said natural gas is stored in a gas tank (6) at a pressure of more than 15 bar.

6. The method of claim 1, wherein the internal combustion engine is operated with a stoichiometric air/fuel ratio.

7. The method of claim 2, wherein said natural gas is injected between 210° and 90° before top dead center of said piston when the engine is operating in an upper and full torque operating range, otherwise said natural gas is injected prior to 210° before top dead center of said piston.

8. The method of claim 1, wherein said natural gas substantially comprises methane.

9. An internal combustion engine, comprising:
at least one combustion chamber (12), at least one cylinder (2) with a piston (1) reciprocating within said cylinder, an air intake (3), an intake valve (5), an exhaust (10), an exhaust valve (11) and an injector (8) for injecting compressed natural gas, and
an electronic control unit (9) electronically coupled to said intake valve, said exhaust valve, and said injector wherein said electronic control unit causes said injector to inject said compressed natural gas between 210° and 90° before top dead center of said piston.

10. The internal combustion engine of claim 9, further comprising a storage tank (6) for said natural gas.

11. The internal combustion engine of claim 9 wherein the engine operates on a stoichiometric air/fuel ratio.

12. The internal combustion engine of claim 9 further comprising an exhaust-gas aftertreatment device arranged in the exhaust path of the internal combustion engine.
